(19) United States
(12) Patent Application Publication
(10) Pub. No.: US 2005/0044546 A1
(43) Pub. Date: Feb. 24, 2005

(54) Method of allowing printing from a network attached device

(75) Inventors: Kim Niebling, Smoerum (DK); Theis Olsen, Kastrup (DK); Rickie Skov Sonqvist, Skovlunde (DK); Kenneth Allan Lund, Valby (DK)

Correspondence Address: KLEIN, O'NEILL & SINGH, 2 PARK PLAZA, SUITE 510, IRVINE, CA, 92614, US

(73) Assignee: EuroForm A/S, Smoerum (DK)

(21) Appl. No.: 10/884,189

(22) Filed: Jul. 2, 2004

Related U.S. Application Data
(60) Provisional application No. 60/485,245, filed on Jul. 3, 2003.

(51) Int. Cl. H04K 1/00; H04L 9/00; G06F 17/60; G06F 9/44; G06F 9/445; G06F 15/16

(52) U.S. Cl. 717/177; 717/172; 717/173; 717/178; 709/229

(57) ABSTRACT

A system for enforcing license terms between the creators of software applications running on virtual machines in network-attached embedded systems, and the users of these software applications, allows trial and demo versions of the software applications, where the user can install and use the software application for a limited time or number of executions, or with a limited feature set. When the software applications are purchased, the restrictions are lifted by the issuing of a unique license key eliminating the need for user-specific builds and redistributing of the software application. The system includes an application manager client in the embedded system designating a software application license request to a predefined web server; a webservice running on the web server that receives the request, validates the user-identifying data, issues a unique license key, and forwards this key to the application manager client; and a license data base containing validated user information.

### CROSS-REFERENCE TO RELATED APPLICATION

This application claims the benefit, under 35 U.S.C. Section 119(e), of co-pending provisional application No. 60/485,245; filed Jul. 3, 2003, the disclosure of which is incorporated herein by reference.

### FEDERALLY-SPONSORED RESEARCH OR DEVELOPMENT

Not Applicable

### BACKGROUND OF THE INVENTION

1. Field of the Invention

The invention relates to a method of automated registering and activating of licensed software products running on virtual machines such as a Java Virtual Machine (JVM) in embedded systems connected to a network such as a local area network (LAN) or a wide area network (WAN) ensuring legal use of the product.

2. Description of Related Technology

The state of the art provides several techniques for obtaining a license key for any licensed software product. Thus the state of the art provides various systems and methods of registration and activation of licensed software products. However, the state of the art fails to provide a method and system for automated registration and activation of licensed software applications in network attached embedded systems.

Previously the preferred way distributing license keys for licensed software products was by using dedicated hardware devices many times referred to as Dongles. This was very costly and it required that a hardware device be shipped to each and every user.

Colosso, in U.S. Pat. No. 6,169,976, describes a method and apparatus for regulating the use of licensed products. This method requires the user to connect to a database on a server and to request the licensed product to be activated. In response, the server generates a license key. The user then installs the licensed product and provides the license key information during the installation process.

Griswold, in U.S. Pat. No. 5,940,504, describes a license management system and method for recording the use of a licensed product, and for controlling its use in accordance with the terms of license. The described system and method includes a license check monitor in the licensed product that checks the licensed product's license status with the license control system at regular time intervals, thus requiring that the licensed product has access to the license control system at all times. Furthermore, it assumes that the licensed product is implemented on a network node attached to a communication network that includes the licensor, which limits the use of the invention to intranets.

Lau, in U.S. Pub. No. US 2002/0091943 A1, describes a method and system for encouraging users of computer readable content to register. This method involves embedding of instruction codes in the software products operable to direct the processor circuit to automatically establish a connection to a server for registration. This method is not relevant for embedded systems with proprietary operating systems.

Franklin et al., in International Pub. No. WO 01/50319 A2, describes a system and a method for providing a license management system, wherein customers utilize computers to connect to a license management system via a communication line. The license management system can be used with varying types of content and allows the owner of the content to have full control of access to the content.

All of the above mentioned publications are hereby incorporated in the present specification by reference.

### SUMMARY OF THE INVENTION

An object of the present invention is to provide a system and method enabling fully automated registration of licensed software in network attached embedded systems such as printers, multi-function devices and facsimile devices. The software application (SA) can be distributed freely, but when installed in the embedded system, certain restrictions in the use of the software will apply. At start-up, the SA will contact the application manager (AM), also running in the embedded system, with registration information, such as SA name and version. If the SA is licensed, the AM replies that the SA is licensed, and the SA will run without any restrictions. On the other hand, if the SA is not licensed, the AM will contact a web server over a private or public network with the SA information and some device specific information. A webservice running on the web server will validate the registration information against the license database, and if a license has been purchased, the webservice will reply with a license key for that particular SA in the specific embedded system. The AM then holdS the license keys for the different SAs locally in the embedded system.

A further object of the invention is to provide a system and method for automatic update service for a SA installed on network attached embedded system. The AM can optionally be configured to check with the webservice if any code updates are available for the SA in question at start-up, and then either download and install these updates automatically, or just notify a system administrator about the availability.

A particular advantage of the present invention is the provision in system and method of using a public network such as the Internet as the communication network, allowing the AM in the network attached embedded system to communicate with the webservice running on a public accessible web server through firewalls, thus eliminating any need for altering an existing infrastructure.

A further advantage of the present invention is the provision of a system and a method of automatically retrieving the license key by the AM running in the network attached embedded system, especially in environments with several hundred devices.

A particular feature of the present invention is the provision of a system and a method of allowing free trial or demo versions of the SA in the network attached embedded system, allowing the user to install and use the software application for a limited time period or number of executions or with a limited feature set alternatively any combination hereof.

The above objects, advantages and features, together with numerous other objects, advantages and features which will become evident from the below detailed description of a preferred embodiment of the present invention, are, according to a first aspect of the present invention, obtained by an automated licensing system for ensuring automatic registration and activation of software applications in network attached embedded systems; said automated licensing system comprising:
(a) a software application or a first plurality of software applications running in a network attached embedded system enhancing existing features or adding new features to the device;
(b) an application manager also running in the embedded system controlling the license rights of the installed software applications and proving automatic registration and activation of the individual software applications;
(c) a communication protocol between the software applications and the application manager;
(d) a private or a public communication network;
(e) a webservice running on a web server connected to the communication network;
(f) a communication protocol between the application manager and the webservice; and
(g) a license data base containing information on all the details on sold software applications.

In the present context, a network attached device is to be considered a device including an embedded processor, such as a printer, a combined printer and scanner, a fax machine, a Personal Digital Assistant (PDA) or other mobile units, but not including network attached personal computers or the like.

According to a second aspect of the present invention, a method of allowing operation of a network attached device comprises the steps of:
(i) downloading a software application including an application manager from a server connected to the network;
(ii) installing the software application on the network attached device;
(iii) in a first alternative, executing at least one device operation by means of the software application for allowing a user to evaluate the software application prior to licensing the software application, or in a second alternative not allowing execution of any device operations;
(iv) requesting license information by sending a request from the network attached device to the server, the request including device specific information;
(v) sending license information including license status from the server to the network attached device;
(vi) inputting the license information including the license status to the network attached device;
(vii) the application manager forwarding the license status to the software application, the software application being enabling in the first alternative, provided the software application has not been executed or the software application has been licensed, alternatively the software application being non-enabling, provided the software application has not being licensed or in the first alternative provided the software application has executed the at least one device operation; and
(ix) provided the software application being enabling, allowing the device operations or alternatively, provided the software application being non-enabling, blocking the device operation or operations.

The method may further comprise the software application automatically sending a request to the server including a request for updating the software application. The server does not need to be identical to the server comprising the license information.

The method may further comprise automatically updating the license status and/or counting the number of executions performed by said software application. The counting may be performed by any of the components in the software, such as the software application or the application manager, alternatively by a third component.

The counting may result in the software application or license status being non-enabled by exceeding an upper threshold of the number of executions allowed, e.g. the software application may be distributed with a limitation of 10 trial executions.

The software application or license status may be non-enabled by exceeding a time limitation, e.g. the software application may be distributed with a 30 day trail period limitation.

Further alternatively, the license status or software application may be permanently enabled, however blocking certain features of said software application. Alternatively, this may be combined with any one or more of the above mentioned limitation options.

According to a third aspect of the present invention, the step (i) is substituted by the step of copying the software application, including the application manager, from a data-carrying medium, such as an optical compact disk. This operation may be performed from a local area network server or any other network attached computer.

According to a fourth aspect of the present invention, the step (i) is initiated by a user request sent from a computer attached to the network to the server, the software application being downloaded to the computer and installed in the network attached device, alternatively the software application being downloaded directly to and installed into said network attached device.

The network mentioned in all of the above mentioned aspects, objects, advantages and features of the present invention may be a local area network, the local area network being attached to a public network, such as the Internet. The local area network may include a firewall. The connection from the network attached device to the network may be constituted by means of wireless connection, two-wire, twisted-pair, optical fibers, or any other means.

The method according to the second aspect of the present invention may include any of the objects, advantages and features of the first aspect of the present invention or combinations thereof. Also, the system according to the first aspect of the present invention may include any of the objects, advantages and features of the second aspect of the present invention or combinations thereof.

### BRIEF DESCRIPTION OF THE DRAWINGS

FIG. 1 shows a schematic overview of the automated license system.

FIG. 2 shows a principal flow diagram of the Client (Embedded) System, a sub element in the automated license system.

FIG. 3 shows a principal flow diagram of the Server System, a sub element in the automated license system.

FIG. 4 shows a representative diagram of the data packages exchanged in Client (Embedded) System between the Solution 10 and Client Service 11.

FIG. 5 shows a representative diagram of the data packages exchanged in Communication Network between Client Service 11 and Server Service 17.

### DETAILED DESCRIPTION OF THE INVENTION

In the following description, the automated licensing system according to the preferred embodiment of the present invention will be described in detail with reference to the figures listed below.

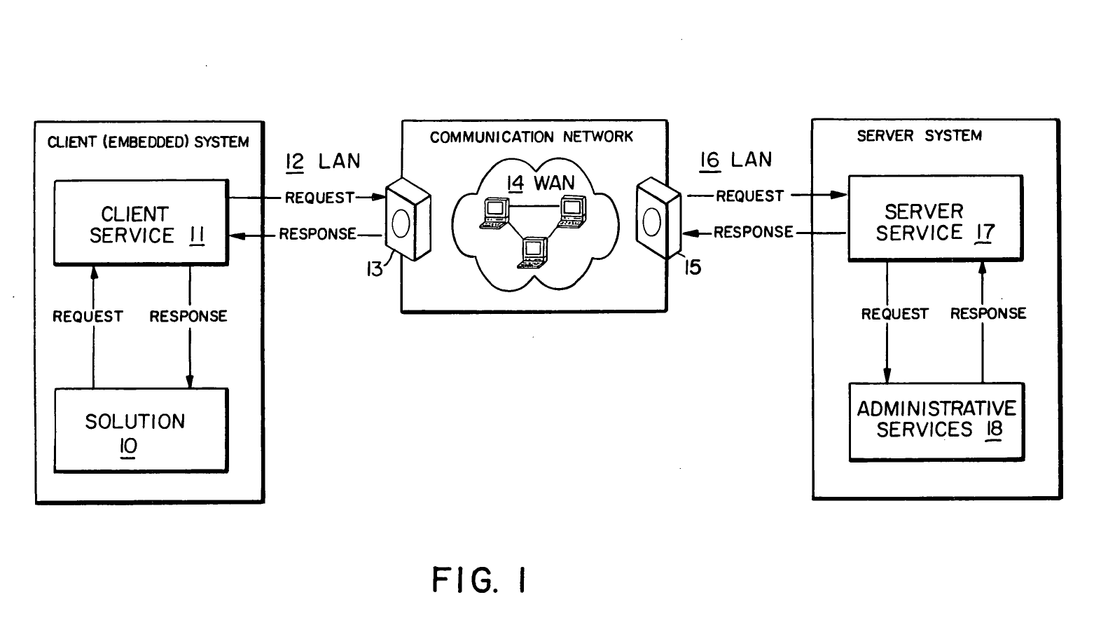

FIG. 1 shows a schematic overview of the automated license system in its entirety. A Client Service 11 can communicate over a Communication Network 14 to the Server Service 17 requesting licensing information for a given Solution 10 installed on Client (Embedded) System. The Communication Network may comprise several LAN's 12, 16 and WAN 14 with attached firewalls 13, 15, but the communication is carried on by standardized protocols that are capable of bypassing firewalls 13, 15 etc. and without causing a security threat to existing systems and technology.

A Solution 10 provides some kind of functionality to the Client (Embedded) System, but without proper license information, the functionality set is limited. To receive license information, it communicates internally within the Client (Embedded) System where the Client Service 11 is also present. If the Client Service 11 does not hold previous received license information for the Solution 10, it performs a communication process with the Server Service 17, exchanging specific information about the Solution 10 and the Client (Embedded) System. The Server Service 17 validates received information, possibly in cooperation with other Administrative Services 18 such as order and billing systems, and responds with license information to the Client Service 11. The Client Service 11 has the option to store the license information, which will avoid the need for further communication with the Server Service 18, referred to as a static licensing. Dynamic licensing is also an option, where every request from Solution 10 is validated by communicating with the Server Service 18. Static licensing enables continuous use of network-disconnected embedded systems which already have receive license information.

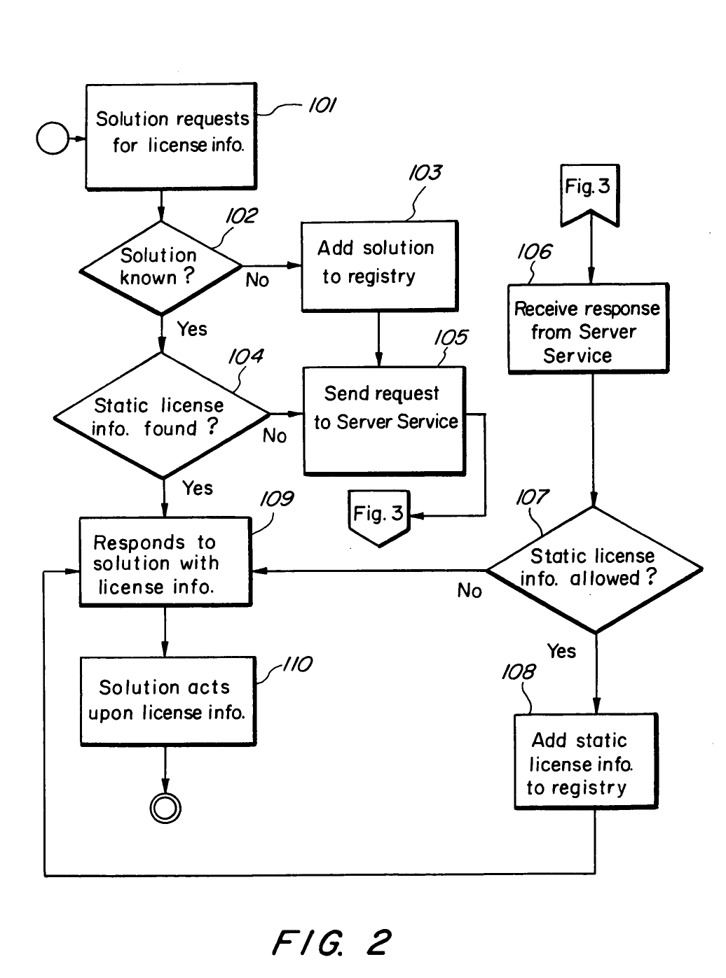

FIG. 2 shows a principal flow diagram of the Client (Embedded) System designated by numeral 101 in its entirety and describing the process pattern in steps 101-110, in which the Solution 10 communicates with the Client Service 11. The specific data packages (license information) transmitted in requests and responses will be described later.

Initially both the Solution 10 and the Client Service 11 are installed on the Client (Embedded) System. At certain intervals or by condition changes in the Client (Embedded) System, the Solution 10 will send a request 101 for license information to the Client Service 11. Condition changes can be hardware conditioned such, as a reboot or reconfiguration of the Client (Embedded) System or simply invoked by the Client Service 11 or other occurring events.

When the Client Service 11 receives the request 101 for license information, it first checks its own registry 102 to see if the Solution 10 is known. If the Solution 10 is already known, the Client Service 11 checks for license information, and if static licensing is allowed 104. If so, the Client Service 11 responds 109 to the Solution 10 with license information. If the Solution 10 is not found in the registry, the Client Service 11 adds 103 the Solution 10.

If the Solution 10 was not found or static licensing was not allowed, the Client Service 11 will initiate a communication process with the Server Service 17 on the Server System by sending a request 105. Dependent on selected network protocol for communication, bandwidth of physical network, amount of network hardware points to pass, the response time from the Server Service 17 can vary. When the Client Service 11 receives the response 106 from the Server Service 17, it adds 108 the license information to its registry if static licensing is allowed 107. Finally, the Client Service 11 responds to the Solution 10 with license information, and the Solution can now take action upon the received license information.

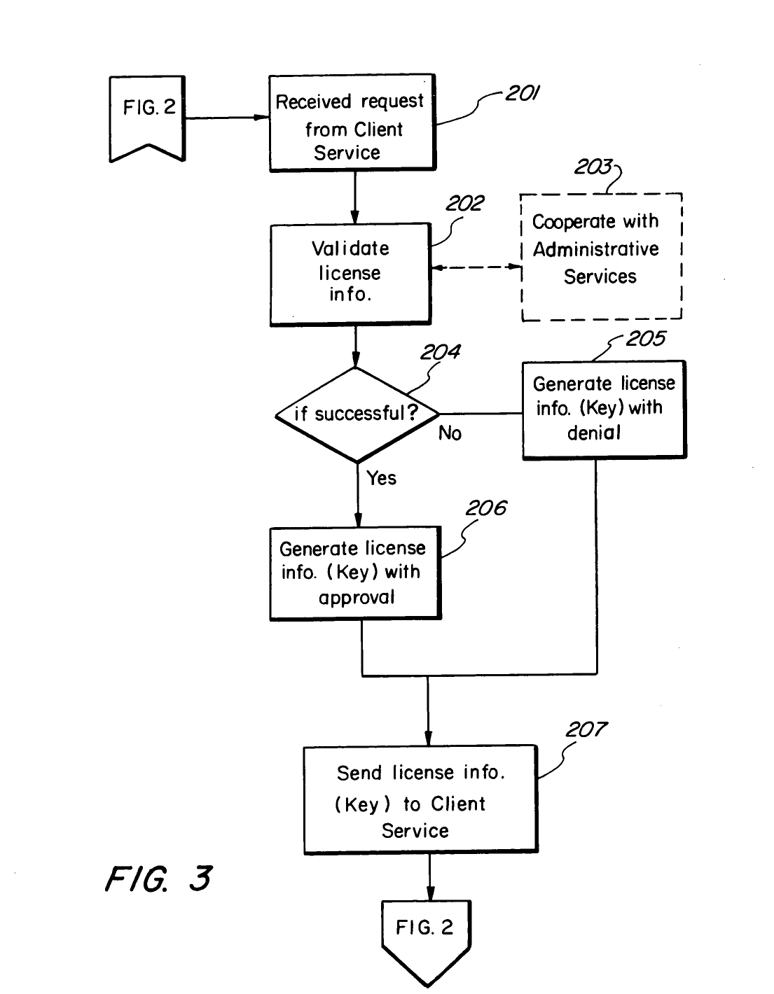

FIG. 3 shows a principal flow diagram of the Server System designated by numeral 201 in its entirety and describing the process pattern in steps 201-207. The specific data packages (license information) transmitted in requests and responses will be described later.

The Server Service 17 can handle requests 201 from multiple Client Services 11. When a request is received, it validates 202 the license information, e.g. in cooperation with other Administrative Services, such as order and billing systems 203. The result of the validation 204 may be either successful, thereby allowing generation of license information (Key) with approval 206, or unsuccessful, thereby declining the approval and generation of license information (Key) with a denial 205. In every circumstance, the license information is sent 207 back to the Client Service 11, which then uses the license info. to respond to the Solution 10 that originally requested the license information.

In the previous descriptions, the license information was an abstract conception of data. The license information is representative differently when sent between Services and Systems.

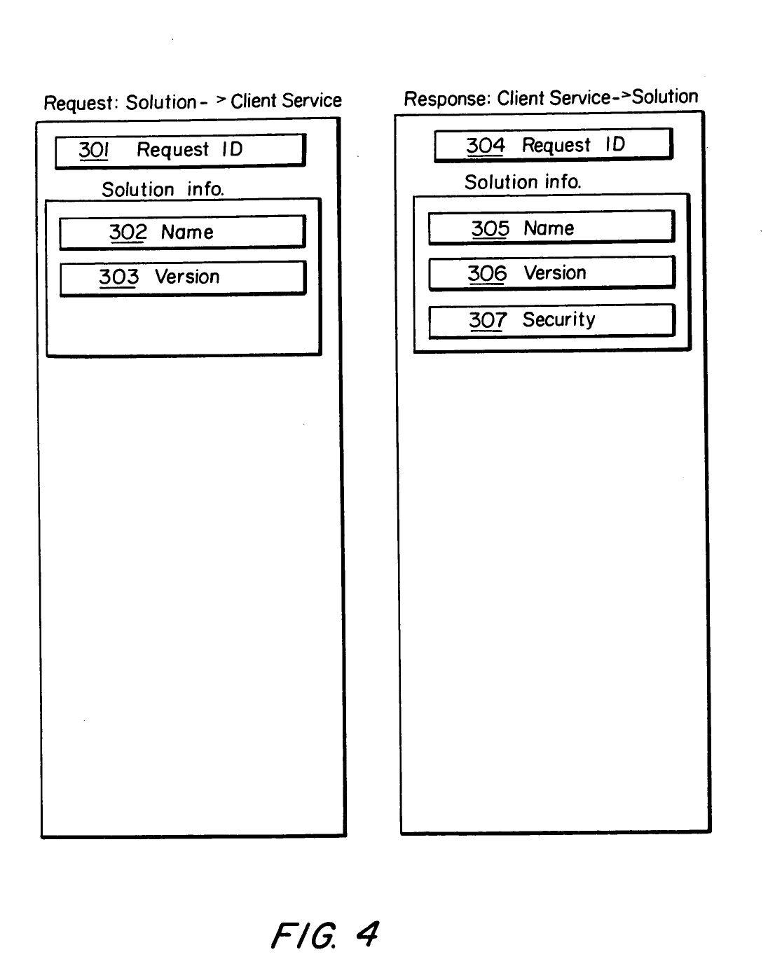

FIG. 4 shows a representative diagram of the data packages (license information) exchanged in the Client (Embedded) System between the Solution 10 and the Client Service 11. Representation of data is designated by numeral 301.

First of all, data in requests and responses in the Client (Embedded) System may be encrypted so malicious attackers will not be able to sniff requests or responses and make any sense of the data.

When the Solution 10 requests license information from the Client Service 11, it sends a data package containing a unique Request ID 301 and information about the solution, its Name 302 and Version 303. The Request ID 301 ensures authentication and that requests cannot be replayed by accident or by malicious attackers. The Name 302 and Version 303 are used to identify the Solution 10 for both the Client Service 11 and in the possible communication with the Server Service 17. The Version 303 is important, because license approval can be dependent on solution version.

When the Client Service 11 receives the request from the Solution 10, it first checks its own registry for stored license information. If this is found and static licensing is allowed, the Client Service 11 can respond to the Solution 10 with a response containing again the Request ID 304, Name 305 and Version 306 of the Solution 10 which is identical to the request and then a Security 307. The Security 307 is a solution-specific identification for the license mode that only the Solution 10 understands. A Security 307 with the value “0” could, e.g., mean that the solution was denied, and the value “1” could mean that it was approved, performing its functionality in the Client (Embedded) System. This is part of the architecture of the Solution 10.

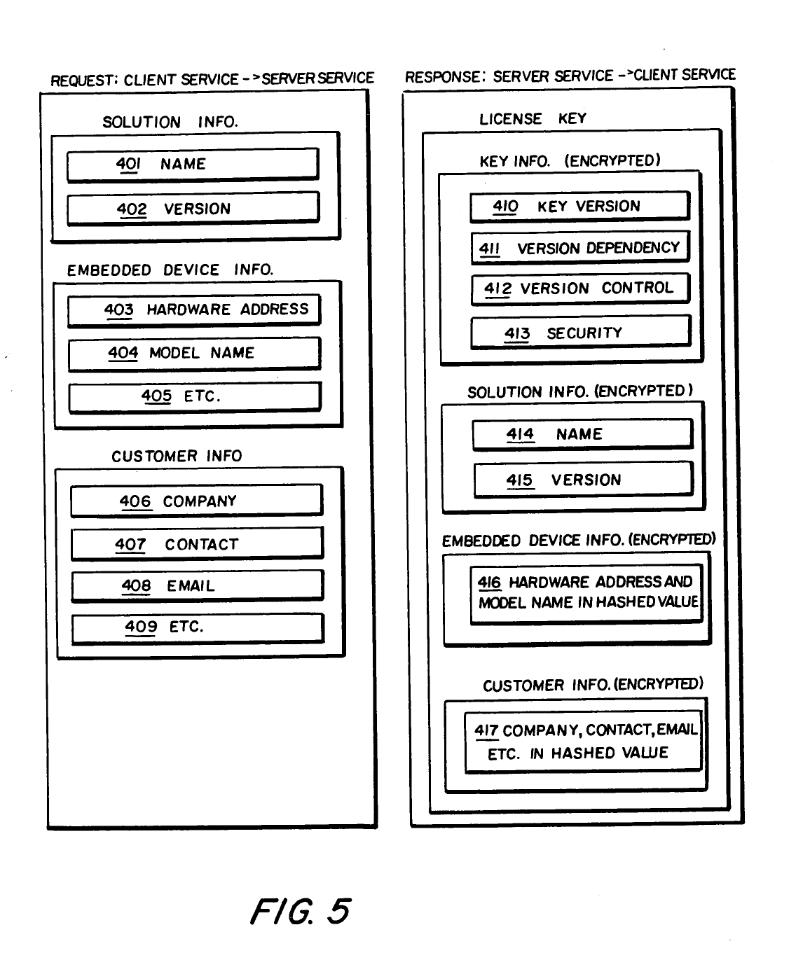

FIG. 5 shows a representative diagram of the data packages exchanged in the Communication Network between the Client Service 11 and the Server Service 17. Representation of data is designated by the numeral 401.

If no license information is found in the Client Service 11 registry or static licensing is not allowed upon a Solution 10 request for license information, the Client Service 11 must initiate communication with the Server Service 17. The request contains three blocks of data, solution information, embedded device information, and customer information. The solution information is identical to the data in requests and responses between the Solution 10 and the Client Service 11, Name 401 and Version 402 for the Solution 10.

The embedded device information is specific information about the Client (Embedded) System that uniquely identifies it. The Hardware Address 403 is the physical network address, where Model Name 404 is a name separating different kinds of embedded devices used for license differentiation.

The customer information is specific information about the customer that has bought the Solution 10. The name of Company 406, name of Contact 407 and the contacts Email 408 address are required.

Additional information 405, 409 for both the embedded device and the customer is possible, but is not used directly for issuing approved license information in the Server Service 17.

When the Server Service 17 receives the request from Client Service 11, it then starts to validate the license information, e.g., in cooperation with other Administrative Services, such as order and billing systems. If required criteria for approval are met, the Server Service 17 generates a License Key which is sent back to the Client Service 11. Otherwise an empty License Key will be sent and inform the Client Service 11 that license validation was unsuccessful.

A License Key comprises four blocks of data. Each block is encrypted. The first block is a key information block that contains a Key Version 410 so the Client Service 11 will know how to interpret the received License Key. The Version Dependency 411 and Version Control 412 are used in static licensing mode to validate in the Client Service 11 if the Solution 10 requesting Version 303 is allowed to use Security 307. In case a new version of the Solution 10 is installed on the Client (Embedded) System, the license conditions might be that this version is not allowed with an earlier-used License Key.

The Security 413 is identical to the Client Service 11 response Security 307 to the Solution 10. The Security 413 is a solution specific identification for the license mode, which only the Solution 10 understands. A Security 413 with the value “0” could, e.g., mean that the solution was denied, and the value “1” could mean that it was approved, performing its functionality in the Client (Embedded) System. This is part of the architecture of the Solution 10.

The second block is the solution information with the Solution 10 Name 414 and the Version 415 which the license is issued for. The third and fourth blocks are, respectively, embedded device information 416 and customer information 417 in hashed value. They are hashed to compress their size, and a hashed value is enough to check if embedded device information and customer information are valid.

When the Client Service 11 receives the License Key, it stores it in its registry and performs its own validation to ensure that the License Key values of key information, solution information, embedded device information, and customer information matche the actual values on the Client (Embedded) System. Finally, it responds with a response to the Solution 10.

1. A method of allowing operation of a network attached device, said method comprising the steps of:
(i) inputting a software application including an application manager to said device;
(ii) installing said software application on said network attached device;
(iii) in a first alternative, executing at least one device operation by means of said software application for allowing a user to evaluate said software application prior to licensing said software application, or in a second alternative not allowing execution of any device operations;
(iv) requesting license information by sending a request from said network attached device to said server, said request including device specific information;
(v) sending license information including license status from said server to said network attached device;
(vi) inputting said license information including said license status to said network attached device;
(vii) forwarding said license status by said application manager to said software application, said software application being enabling in said first alternative provided said software application has not been executed or said software application has been licensed, alternatively said software application being non-enabling provided said software application has not being licensed or in said first alternative provided said software application has executed said at least one device operation; and
(viii) provided said software application being enabling, allowing said device operations or alternatively, provided said software application being non-enabling, blocking said device operation or operations.

2. The method according to claim 1, wherein said step (vi) further comprises a step selected from the group consisting of at least one of automatically updating said license status, and counting the number of executions performed by said software application.

3. The method according to claim 2, wherein said license status is non-enabled by exceeding an upper threshold of the number of executions allowed.

4. The method according to claim 1, wherein said license status is non-enabled by exceeding a time limitation.

5. The method according to claim 1, wherein said license status is permanently enabled but with blocking certain features of said software application.

6. The method according to claim 1, wherein said step (i) comprises a step selected from the group consisting of downloading the software application including said application manager from a server connected to said network, and copying said software application including said application manager from a data carrying medium.

7. The method according to claim 1, wherein said step (i) is initiated by a user request sent from a computer attached to said network to said server, said software application being downloaded to said computer and installed in said network attached device.

8. The method according to claim 1, wherein said software application is downloaded directly to and installed into said network attached device.

9. The method according to claim 1, wherein said step (i) is initiated by a request sent from said software application to said server

10. The method according to claim 9, wherein said request includes a request for updating said software application.

11. The method according to any of the claims 1 to 10, wherein said network is a local area network, said local area network being attached to a public network, said local area network including a firewall.

12. The method according to any of the claims 1 to 10, wherein said network attached device is a printer.

13. An automated licensing system for ensuring automatic registration and activation of software applications in network attached embedded systems, said automated licensing system comprising:
a software application running in a network attached embedded system;
an application manager, also running in said embedded system, and controlling license rights of said software application and proving automatic registration and activation of said software application;
a first communication protocol between said software application and said application manager;
a communication network;
a webservice running on a web server connected to said communication network;
a second communication protocol between said application manager and said webservice; and
a license data base comprising information regarding said software application.
